(19) United States
(12) Patent Application Publication
(10) Pub. No.: US 2026/0110601 A1
(43) Pub. Date: Apr. 23, 2026

(54) ABNORMALITY DETECTION APPARATUS AND ABNORMALITY DETECTION METHOD FOR SUBSTRATE SUPPORT DEVICE

(71) Applicant: EBARA CORPORATION, Tokyo (JP)

(72) Inventors: Mitsuru MIYAZAKI, Tokyo (JP); Hozumi ENDO, Tokyo (JP); Kohei WAKUI, Tokyo (JP); Michiaki MATSUDA, Tokyo (JP); Hiroki YOKOZAWA, Tokyo (JP)

(21) Appl. No.: 19/364,203

(22) Filed: Oct. 21, 2025

(30) Foreign Application Priority Data
Oct. 23, 2024 (JP) 2024-186569

(51) Int. Cl. G01M 99/00; G01H 1/00

(52) U.S. Cl. CPC G01M 99/008; G01H 1/00

(57) ABSTRACT

Provided is a technology capable of detecting abnormality in operation of support members of a substrate support device. An abnormality detection apparatus 20 for a substrate support device 10 includes a sensor 80 configured to detect vibration information or sound information generated when a plurality of support members 40 move, and a controller 70 configured to detect abnormality in the operation of the plurality of support members 40 based on the information detected by the sensor 80.

### TECHNICAL FIELD

The present invention relates to an abnormality detection apparatus and an abnormality detection method for a substrate support device. This application claims priority to Japanese Patent Application No. 2024-186569, filed on Oct. 23, 2024. The entire disclosure of Japanese Patent Application No. 2024-186569, including the specification, claims, drawings, and abstract, is incorporated herein by reference in its entirety.

### BACKGROUND ART

Conventionally, a substrate support device for supporting a substrate is known to include: a base having a plurality of holes; a plurality of support members configured to support the substrate, each of the plurality of support members being inserted into each of the plurality of holes in the base; and a drive device configured to move the plurality of support members in a vertical direction with respect to the base (see, for example, PTL 1 and PTL 2). In such a substrate support device, each of the plurality of support members is provided with a stopper positioned above the base. The plurality of support members are configured to move between a “lower position,” where the stoppers contact an upper surface of the base, and an “upper position,” where the stoppers are separated from and are positioned above the upper surface of the base, driven by the drive device.

### CITATION LIST

### Patent Literature

PTL 1: Japanese Unexamined Patent Application Publication No. 2020-170800
PTL 2: Japanese Unexamined Patent Application Publication No. 2009-295751

### SUMMARY OF INVENTION

### Technical Problem

In conventional substrate support devices such as those described above, malfunctions may occur in the operation of the support members. For example, when an abnormality occurs in the operation of some of the plurality of support members, it is conceivable that the stoppers will fail to contact the upper surface of the base. In this case, it may become difficult to properly support the substrate using the support members. Therefore, there is a need for the development of technology capable of detecting abnormalities in the operation of the support members of the substrate support device.

The present invention has been made in light of the above-described considerations, and one of its objectives is to provide a technology capable of detecting abnormal operation of the support member in the substrate support device.

### Solution to Problem

### Aspect 1

To achieve the above-described objective, one aspect of the present invention is an abnormality detection apparatus for a substrate support device. The substrate support device includes a base, a plurality of support members, and a drive device. The base has a plurality of holes. The plurality of support members are configured to support a substrate. Each of the plurality of support members is inserted into each of the plurality of holes in the base. The drive device is configured to move the plurality of support members in a vertical direction with respect to the base. Each of the plurality of support members is provided with a stopper at a location above the base. The plurality of support members are configured to be driven by the drive device to move between a lower position where the stoppers contact an upper surface of the base and an upper position where the stoppers move away from the upper surface of the base and are positioned above the upper surface. The abnormality detection apparatus includes a sensor configured to detect information about a vibration or a sound produced when the plurality of support members move, and a controller configured to detect abnormality in operation of the plurality of support members based on the information detected by the sensor.

According to the aspect, it is possible to detect an abnormality in the operation of the support members based on information about the vibration or the sound generated when the support members of the substrate support device move.

### Aspect 2

In the above-described aspect 1, the information may be vibration information or sound information generated when the plurality of support members move downward.

### Aspect 3

In the above-described aspect 1 or aspect 2, the controller may detect abnormality in the operation of the plurality of support members by comparing the information detected by the sensor with a preset standard.

### Aspect 4

To achieve the above-described objective, one aspect of the present invention is an abnormality detection method for a substrate support device. The substrate support device includes a base, a plurality of support members, and a drive device. The base has a plurality of holes. The plurality of support members are configured to support a substrate. Each of the plurality of support members is inserted into each of the plurality of holes in the base. The drive device is configured to move the plurality of support members in a vertical direction with respect to the base. Each of the plurality of support members is provided with a stopper at a location above the base. The plurality of support members are configured to be driven by the drive device to move between a lower position where the stoppers contact an upper surface of the base and an upper position where the stoppers move away from the upper surface of the base and are positioned above the upper surface. The abnormality detection method includes: detecting information about a vibration or a sound produced when the plurality of support members move; and detecting abnormality in operation of the plurality of support members based on the detected information.

According to the aspect, it is possible to detect an abnormality in the operation of the support members based on information about the vibration or the sound generated when the support members of the substrate support device move.

### BRIEF DESCRIPTION OF DRAWINGS

FIG. 1 is a schematic diagram for describing a configuration of a substrate processing apparatus according to an embodiment;

FIG. 2 is a schematic diagram illustrating an example state in which support members according to the embodiment are positioned in the “upper position;”

FIG. 3 is a schematic diagram illustrating an example state in which a plurality of the support members according to the embodiment are seen from an upper side;

FIG. 4 is a flowchart illustrating an example of an abnormality detection method according to the embodiment; and

FIG. 5 is a schematic diagram illustrating an example of a situation in which an abnormality occurs in some of the plurality of support members according to the embodiment.

### DESCRIPTION OF EMBODIMENTS

### Embodiment

The embodiments of the present invention will now be described with reference to the accompanying drawings. The drawings are schematically illustrated to aid in understanding the features, and the dimensional ratios of the components might not necessarily reflect their actual proportions. Additionally, the drawings include X-Y-Z Cartesian coordinates as required. In this Cartesian coordinate system, a Z-direction represents the upward direction, while a −Z-direction represents the downward direction, which corresponds to the direction of gravitational force.

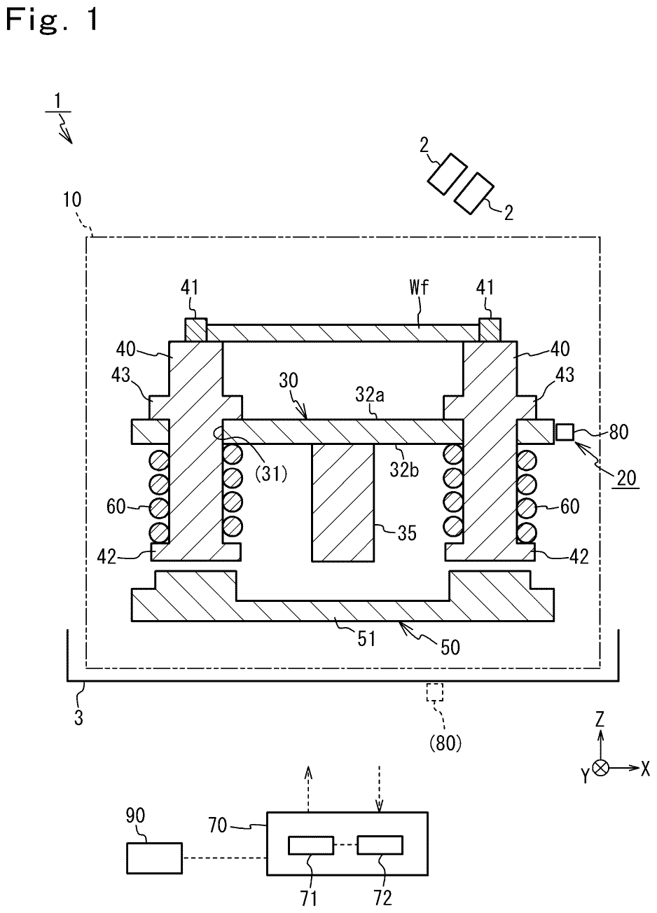

FIG. 1 is a schematic diagram for describing a substrate processing apparatus 1 according to the embodiment. The substrate processing apparatus 1 according to the embodiment is an apparatus configured to perform a predetermined process on a substrate Wf. Specific examples of the predetermined processes are not limited. For example, various processes such as a cleaning process and a drying process can be employed. In this embodiment, a cleaning process is exemplified as the predetermined process.

In this case, the substrate processing apparatus 1 may include a cleaning nozzle 2 configured to discharge a cleaning liquid toward the substrate Wf, as illustrated in FIG. 1.

With this configuration, the substrate Wf can be cleaned using the cleaning liquid discharged from the cleaning nozzle 2. In this case, the substrate processing apparatus 1 may include a cleaning tank 3 configured to collect the cleaning liquid after cleaning.

As illustrated in FIG. 1, the substrate processing apparatus 1 includes a substrate support device 10 configured to support the substrate Wf. In the substrate processing apparatus 1, the predetermined process is performed on the substrate Wf while the substrate Wf is held by the substrate support device 10. In FIG. 1, the substrate support device 10 is schematically illustrated in cross section.

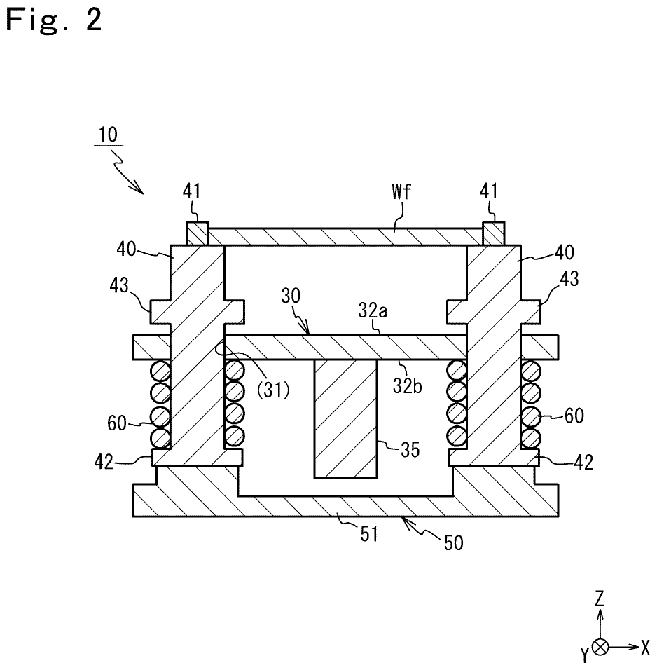

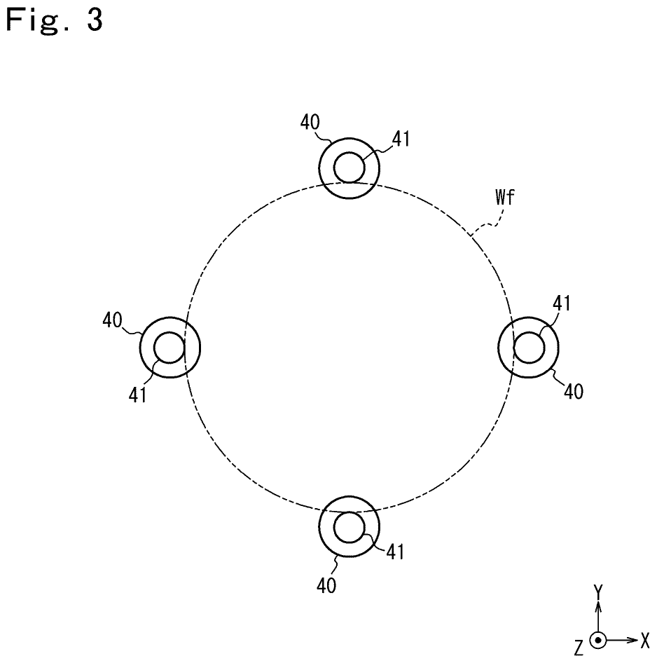

As illustrated in FIG. 1, the substrate support device 10 includes a base 30, a plurality of support members 40, a drive device 50, and a controller 70. The substrate support device 10 may include an elastic member 60. FIG. 1 illustrates the example state where the support members 40 are in the “lower position” as described hereinafter. FIG. 2 is a schematic diagram illustrating the example state of the support members 40 in the “upper position” as described below. FIG. 3 is a schematic diagram illustrating the example state in which the plurality of support members 40 are seen from the upper side.

Referring to FIG. 1, the controller 70 according to the embodiment, as an example, is configured to collectively control the substrate processing apparatus 1, the substrate support device 10, and an abnormality detection apparatus 20 described below. However, the configuration of this embodiment is not limited to the above-described description. This embodiment can be configured, for example, with a controller for controlling the substrate processing apparatus 1, a controller for controlling the substrate support device 10, and a controller for controlling the abnormality detection apparatus 20, each of which may be provided separately.

The controller 70 is constituted by a computer. Specifically, the controller 70 (that is, the computer) includes a processor 71 and a storage device 72, which serves as a non-transitory storage medium, among other components. In the controller 70, the processor 71 controls the operation of the controlled component based on instructions from a program stored in the storage device 72.

Referring to FIGS. 1 and 2, the base 30 according to the embodiment is constituted of a plate member extending horizontally. The base 30 is a member that supports the support members 40, which will be described below. In a portion of the base 30, a plurality of holes 31 that extend therethrough in the vertical direction are provided. The support members 40, as described below, are inserted into the respective holes 31. The base 30 in this embodiment is supported by a support shaft 35.

The support shaft 35 may be connected to a rotation mechanism (not illustrated) and is configured to rotate by means of this rotation mechanism. In this case, the base 30, which is supported by the support shaft 35, is capable of rotating. This allows the support members 40, which is engaged with the base 30, to rotate, thereby rotating the substrate Wf supported on the support members 40. According to this configuration, for example, when performing the predetermined process on the substrate Wf, the substrate Wf supported by the substrate support device 10 can be rotated while the predetermined process is being applied to the substrate Wf.

Referring to FIGS. 1, 2, and 3, the plurality of support members 40 are configured to support the substrate Wf. The plurality of support members 40 are configured to move in the vertical direction with respect to the base 30 when actuated by the drive device 50. The number of support members 40 is not particularly limited. However, in this embodiment, as an example, there are four.

In this embodiment, each of the plurality of support members 40 is constituted as a support pin extending in the vertical direction. Each support member 40 is configured to pass through a corresponding hole 31 in the base 30.

A clamp 41 may be provided at an upper end of each support member 40. In this embodiment, the support members 40, for example, have portions other than the clamp 41 at the upper ends of the support members 40 that support an outer peripheral edge of the lower surface of the substrate Wf from below, while the clamps 41 support an outer peripheral side surface of the substrate Wf.

The plurality of support members 40 support the substrate Wf in such a manner that the substrate Wf remains horizontal under a normal state (that is, when the support members 40 are operating without any abnormality).

The lower ends of the support members 40, which are positioned below the base 30, are provided with enlarged lower end portions 42 that extend outwardly in a radial direction of the support members 40.

The elastic member 60 is disposed between the enlarged lower end portion 42 of the support member 40 and a lower surface 32b of the base 30. The elastic member 60 according to the embodiment biases the support member 40 downward. The specific configuration of the elastic member 60 is not particularly limited. However, in this embodiment, a coil spring is used as an example of the elastic member 60.

Stoppers 43 are disposed on the support members 40 at positions between their upper and lower ends, and located above the base 30. In this embodiment, the stopper 43 is, for example, constituted as an enlarged portion of the support member 40, which is expanded outwardly in the radial direction on the outer peripheral side.

The location where the stopper 43 comes into contact with an upper surface 32a of the base 30 is referred to as the “lower position” (see FIG. 1). The position where the stopper 43 is separated from the upper surface 32a of the base 30 and is positioned above the upper surface 32a is referred to as the “upper position” (see FIG. 2). As illustrated in FIG. 2, in the upper position, the stopper 43 of this embodiment is positioned at a predetermined distance above the upper surface 32a of the base 30. The support members 40 are configured to move between the lower position and the upper position while supporting the substrate Wf.

When the support members 40 move in the vertical direction, vibrations and noises may be generated due to the movement of the support members 40. In this embodiment, a particularly loud vibration and noise may occur when the support members 40 move downward to a lower position, specifically when the stoppers 43 come into contact with the upper surface 32a of the base 30.

The drive device 50 is configured to move the plurality of support members 40 in the vertical direction with respect to the base 30 (that is, elevation and descent). The specific configuration of the drive device 50 is not limited as long as it fulfills the described function. For example, as an example of the drive device 50, a known drive device (or lifting device) may be used, which includes an engaging portion 51 configured to engage with the support members 40, and an air cylinder (not illustrated) that raises and lowers the engaging portion 51 using, for example, air pressure. The controller 70 controls the operation of the drive device 50.

The engaging portion 51 of the drive device 50 contacts the lower ends of the support members 40 and moves the support members 40 upward, thereby positioning the support members 40 in an “upper position.” By moving the engaging portion 51 of the drive device 50 downward and away from the lower ends of the support members 40 (that is, disengaging it from the support members 40), the support members 40 can be returned to their lower position.

For example, the substrate Wf can be attached to the support members 40 or detached from the support members 40 while the support members 40 are in the “upper position.” For example, the predetermined process, such as a cleaning process, may be performed on the substrate Wf while the support members 40 are in the “lower position.” However, this is merely an example, and the user may adjust the upper position or the lower position of the support members 40 as desired depending on the situation.

As the substrate support device 10 described above, known substrate support devices, such as those exemplified in PTL 1 and PTL 2, can be applied. Therefore, a more detailed description of the substrate support device 10 is omitted.

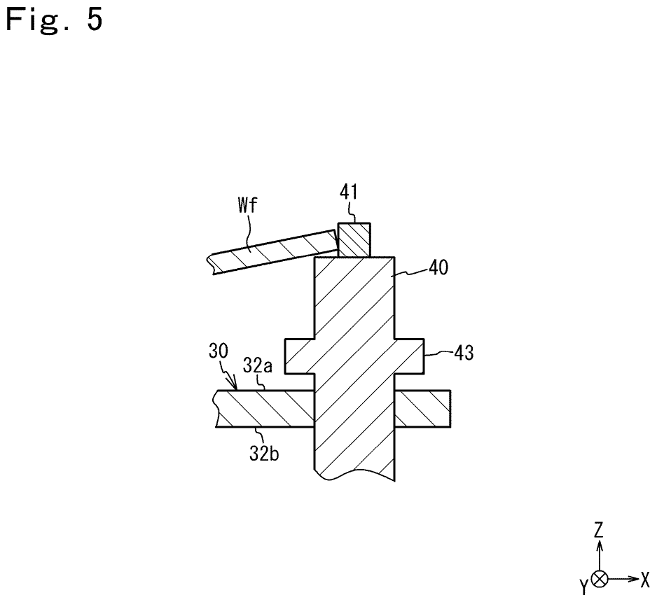

FIG. 5 is a schematic diagram illustrating an example of an abnormality occurring in some of the support members 40 among the plurality of support members 40. For example, it is conceivable that an abnormality may occur in some of the plurality of support members 40, resulting in the stoppers 43 of the support members 40 not coming into contact with the upper surface 32a of the base 30 (that is, not reaching the lower position). Such a condition may occur, for example, when foreign matter is present between the stopper 43 and the upper surface 32a of the base 30, or when there is a malfunction in the mechanism for moving the support members 40 (for example, the drive device 50, the elastic member 60, or the like).

When an abnormality occurs in the support members 40 as described above, the support members 40 may no longer be able to properly support the substrate Wf. Specifically, as illustrated in FIG. 5, there is a risk that the substrate Wf may be supported while the substrate Wf is tilted. In this case, there is a risk that the predetermined process might be applied to the substrate Wf while the substrate Wf is not adequately supported. Therefore, to suppress the occurrence of such issues, the substrate processing apparatus 1 according to the embodiment includes an abnormality detection apparatus 20 (referred to as the “abnormality detection apparatus for the substrate support device”) as described below.

Referring to FIG. 1, the abnormality detection apparatus 20 according to the embodiment includes a sensor 80. The abnormality detection apparatus 20 according to the embodiment also includes the above-described controller 70 as one of its components. The substrate support device 10 and the abnormality detection apparatus 20 may collectively be referred to as the “substrate support system.”

The sensor 80 is configured to detect information about vibration (referred to as vibration information) or information about sound (referred to as sound information) generated when the plurality of support members 40 move. In this embodiment, the phrase “when the support members 40 move (that is, during the movement of the support members 40)” refers to any moment during the movement of the support members 40, from the start to the end of their motion. The sensor 80 transmits detection results (output values) to the controller 70.

When a sensor capable of detecting vibration information is used as the sensor 80, a vibration sensor or an acceleration sensor can be used as a specific example of the sensor 80. On the other hand, when a sensor capable of detecting sound information is used as the sensor 80, an acoustic sensor, for example, can be employed as the sensor 80.

The specific location of the sensor 80 is not restricted, provided it can detect vibrations and sounds from the support members 40. The sensor 80 illustrated in FIG. 1 is, as an example, positioned on the base 30. However, this is merely one example of a possible placement for the sensor 80. In other embodiments, the sensor 80 may be positioned on the support members 40.

Alternatively, the sensor 80 may be positioned, for example, outside the cleaning tank 3, such as on an outer surface of the cleaning tank 3. This configuration suppresses the sensor 80 from being exposed to a cleaning liquid or the like. In this case, the cleaning tank 3 is configured such that the vibrations of the support members 40 are transmitted via a predetermined member (referred to as a vibration transmission member). Alternatively, when the substrate support device 10 and the substrate processing apparatus 1 incorporating this device are housed within an enclosure, the sensor 80 may be positioned on a wall of the enclosure. In this case as well, the enclosure is designed such that the vibrations from the support members 40 are transmitted via the predetermined member.

In this embodiment, the abnormality detection apparatus 20 includes one sensor 80. The number of sensors 80 is not limited to this specific number, and the abnormality detection apparatus 20 may include a plurality of the sensors 80.

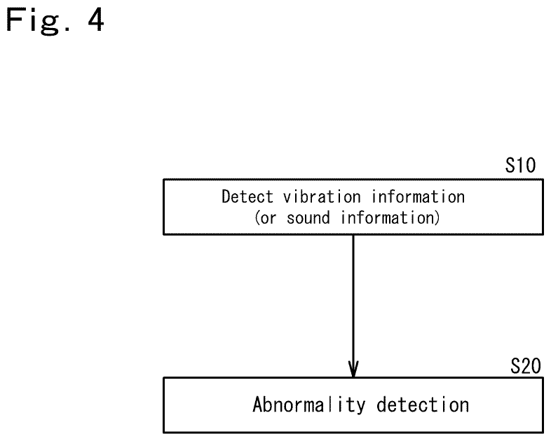

FIG. 4 is a flowchart for describing an example of an abnormality detection method according to the embodiment. In Step S10, the sensor 80 detects vibration information (or sound information) generated when the plurality of support members 40 move. Specifically, the sensor 80 detects the vibration information (or the sound information) at least during the period from the start to the end of the movement of the plurality of support members 40, that is, from the time when the controller 70 sends a movement start command for the support members 40 until the controller 70 sends a movement end command, to the drive device 50.

The sensor 80 may continuously detect the vibration information (or the sound information) during the operation of the substrate processing apparatus 1 (from the start to the end of its operation) and during the operation of the substrate support device 10 (from the time the substrate support device 10 begins supporting the substrate Wf until it ceases to support the substrate Wf). The information detected by the sensor 80 is transmitted to the controller 70.

Next, the controller 70 detects an abnormality in the operation of the plurality of support members 40 based on the information detected by the sensor 80 in Step S10 (Step S20). As a specific example, the controller 70 may detect abnormalities in the operation of the plurality of support members 40 by comparing the information detected by the sensor with the preset standard. The vibration information (or sound information) detected by the sensor 80 during the normal movement of the plurality of support members 40 can serve as the basis for this standard. The controller 70 may accumulate vibration information (or the sound information) during the normal movement of the support members 40 and update the value as the standard based on the accumulated information.

As a specific example of Step S20, the controller 70 may detect an abnormality in the downward movement of the plurality of support members 40 based on the vibration information (or the sound information) generated when the plurality of support members 40 move downward. Specifically, in this case, the controller 70 may detect the abnormality in the movement operation of the support members 40 based on the vibration information (or the sound information) generated when the stopper 43 contacts the upper surface 32a of the base 30.

Specifically, in this case, the controller 70 detects the abnormality in the downward movement operation of the plurality of support members 40 by comparing the information detected by the sensor 80 with the preset standard (the vibration information (or the sound information) as the standard) when the plurality of support members 40 move downward from the upper position (during the downward movement). The vibration information (or the sound information) detected by the sensor 80 when the plurality of support members 40 move “normally” downward to the lower position can serve as the basis for this standard. This vibration information (or the sound information) refers to a concept that encompasses the time waveform of vibration (or the sound).

Based on this comparison, the controller 70 may detect the abnormality in the downward movement operation of the support members 40 when no vibration (or sound) is determined to be generated, which would normally occur when the stoppers 43 of the plurality of support members 40 come into contact with the upper surface 32a of the base 30.

The controller 70 may also acquire additional information through frequency analysis based on the information detected by the sensor 80. As a result of this frequency analysis, an “overall value (evaluation value)” as well as individual values for each frequency may be obtained. The overall value refers to a composite value (or a composite power) of all frequency bands in a power spectrum when the power spectrum is derived from the time-domain vibration (or the sound) signal using Fast Fourier Transform (FFT).

An example of this is as follows. For example, consider a scenario where, during the downward movement of the plurality of support members 40, foreign objects become lodged between the stoppers 43 of some of the support members 40 and the base 30. As a result, the stoppers 43 of these specific support members 40 fail to make contact with the upper surface 32a of the base 30, while the stoppers 43 of the other support members 40 do make contact with the upper surface 32a of the base 30. In such a case, the “overall value” obtained by the controller 70 is lower than the reference value, which corresponds to the overall value when all the stoppers 43 of the plurality of support members 40 are in contact with the upper surface 32a of the base 30.

Therefore, when the obtained overall value is lower than the reference value, the controller 70 can detect (or determine) that there is the abnormality in the downward movement operation of the support members 40. Specifically, the controller 70 can detect the occurrence of the abnormality in which the stoppers 43 of some of the support members 40 are not in contact with the upper surface 32a of the base 30.

The so-called “partial overall value” may be used as this overall value. The partial overall value limits the range of frequency bands and represents the composite value of the power spectrum within this limited range of the frequency bands.

Alternatively, the controller 70 may detect the abnormality by determining the “peak value” of the frequency based on the information detected by the sensor 80 and comparing this peak value with a preset standard peak value (a reference value). In this case, the controller 70 can detect the abnormality in the downward movement operation of the support members 40 when the peak value is lower than the reference value.

Alternatively, the controller 70 can acquire temporal timing deviations (differences) in the movement operation of the support members 40 based on the vibration information (or the sound information) detected by the sensor 80, and detect the abnormality in the support members 40 based on this acquired timing deviation. Specifically, in this case, for example, the controller 70 may determine that an abnormality has occurred in the movement operation of the support members 40 when, based on the detection results of the sensor 80, it is determined that the timing at which the stopper 43 contacts the upper surface 32a of the base 30 is later than a normal timing, or the like.

By obtaining the determination result from the controller 70 in Step S20, the user can recognize that an abnormality exists in the support members 40. Specifically, the user can, for example, observe that some of the plurality of support members 40 are not positioned at the lower position (as illustrated in FIG. 5). As a result, the user can determine that the substrate Wf may not be properly supported by the support members 40, and can either stop the operation of the substrate processing apparatus 1 or proceed to repair the substrate support device 10. As a result, it is possible to suppress the predetermined process from being applied to the substrate Wf when the substrate Wf is not properly supported.

The substrate processing apparatus 1 may include a notification device 90 configured to issue an alarm when the controller 70 detects an abnormality in Step S20. The specific configuration of the notification device 90 is not particularly limited. For example, the notification device 90 may use an alarm lamp to indicate an alert through light, a buzzer to indicate an alert through sound, or a display to indicate an alert through textual information.

In the flowchart illustrated in FIG. 4, when the controller 70 detects an abnormality in the operation of the plurality of support members 40 based on the sound information, for example, the controller 70 may detect the abnormality of the support members 40 based on a sliding sound generated when the plurality of support members 40 move (the sliding sound generated between the support members 40 and the base 30).

Specifically, in this case, in Step S10, the sensor 80 detects the sliding sound generated when the plurality of support members 40 move either downward or upward. In Step S20, the controller 70 detects the abnormality in the movement operation of the plurality of support members 40 by comparing the sliding sound detected by the sensor 80 with a preset standard sound, which corresponds to the sliding sound in a normal state. Specifically, the sliding sound of the support members 40 is considered to become louder when, for example, the sliding resistance of the support members 40 during their movement in the vertical direction increases for some reason, resulting in an abnormality in the movement operation of the support members 40. Therefore, the controller 70 may detect the abnormality in the movement operation of the support members 40 when the sliding sound, determined based on the detection value of the sensor 80, exceeds the reference value.

The substrate processing apparatus 1 may include both a sensor 80 that detects vibration information (a vibration information detection sensor) and a sensor 80 that detects sound information (a sound information detection sensor). In this case, the controller 70 may detect the abnormality in the operation of the support members 40 based on at least one of the vibration information detected by the vibration information detection sensor and the sound information detected by the sound information detection sensor.

According to the embodiment described above, it is possible to detect the abnormality in the operation of the plurality of support members 40 based on the vibration information or the sound information generated when the plurality of support members 40 move. This enables, according to this embodiment, the suppression of the predetermined process from being applied to the substrate Wf in cases where the substrate Wf is not properly supported.

In this embodiment, the location of the sensor 80 can be chosen as long as it is a position where it is possible to detect the vibration information or the sound information during the movement of the support members 40, thereby providing a high degree of flexibility in selecting the location of the sensor 80. Therefore, this embodiment can be easily implemented. The abnormality detection apparatus 20 according to the embodiment can be implemented by incorporating the sensor 80 and the controller 70 into an existing substrate support device. In this regard, the abnormality detection apparatus 20 according to the embodiment can be easily implemented.

According to this embodiment, for example, the vibration information or the sound information generated when the plurality of support members 40 move downward a plurality of times can be collected and stored in the storage device 72. In this case, for example, a machine learning can be applied to the accumulated vibration information or sound information to derive the vibration information or the sound information that may serve as an indicator for determining a replacement timing of a component in the substrate support device 10.

While the embodiments of the invention have been described in detail above, the invention is not limited to these specific embodiments, and various modifications and alterations can be made within the scope of the invention as defined by the claims.

### REFERENCE SIGNS LIST

10 . . . substrate support device
20 . . . abnormality detection apparatus
30 . . . base
31 . . . hole
32a . . . upper surface
40 . . . support member
43 . . . stopper
50 . . . drive device
70 . . . controller
80 . . . sensor
Wf . . . substrate

What is claimed is:

1. An abnormality detection apparatus for a substrate support device, wherein
the substrate support device includes:
a base having a plurality of holes;
a plurality of support members configured to support a substrate, each of the plurality of support members being inserted into each of the plurality of holes in the base; and
a drive device configured to move the plurality of support members in a vertical direction with respect to the base, wherein
each of the plurality of support members is provided with a stopper at a location above the base, and
the plurality of support members are configured to be driven by the drive device to move between a lower position where the stoppers contact an upper surface of the base and an upper position where the stoppers move away from the upper surface of the base and are positioned above the upper surface, wherein
the abnormality detection apparatus comprises:
a sensor configured to detect information about a vibration or a sound produced when the plurality of support members move; and
a controller configured to detect abnormality in operation of the plurality of support members based on the information detected by the sensor.

2. The abnormality detection apparatus for the substrate support device according to claim 1, wherein
the information is vibration information or sound information generated when the plurality of support members move downward.

3. The abnormality detection apparatus for the substrate support device according to claim 1, wherein
the controller detects abnormality in the operation of the plurality of support members by comparing the information detected by the sensor with a preset standard.

4. An abnormality detection method for the substrate support device, wherein
the substrate support device includes:
a base having a plurality of holes;
a plurality of support members configured to support a substrate, each of the plurality of support members being inserted into each of the plurality of holes in the base; and
a drive device configured to move the plurality of support members in a vertical direction with respect to the base, wherein
each of the plurality of support members is provided with a stopper at a location above the base, and
the plurality of support members are configured to be driven by the drive device to move between a lower position where the stoppers contact an upper surface of the base and an upper position where the stoppers move away from the upper surface of the base and are positioned above the upper surface, wherein
the abnormality detection method comprises:
detecting information about a vibration or a sound produced when the plurality of support members move; and
detecting abnormality in operation of the plurality of support members based on the detected information.
